(19) United States
(12) Patent Application Publication
(10) Pub. No.: US 2007/0139690 A1
(43) Pub. Date: Jun. 21, 2007

(54) Image processing apparatus and interrupt control method

(75) Inventor: Tamotsu Fukushima, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/584,150

(22) Filed: Oct. 20, 2006

(30) Foreign Application Priority Data
Dec. 16, 2005 (JP) 2005-362670

(51) Int. Cl. G06K 15/00

(52) U.S. Cl. 358/1.14

(57) ABSTRACT

The image processing apparatus comprises an image reading portion for inputting image data, an image forming portion for outputting input image data, and a machine control portion for controlling an interrupt operation. The machine control portion determines an output state at the image forming portion when input of image data from the image reading portion is completed, and, if it is determined that previous image data is being output, it selects between interrupting the previous image data by the input image data and processing the input image data after completion of processing of the previous image data.

### CROSS-NOTING PARAGRAPH

This non-provisional application claims priority under 35 U.S.C. §119(a) on Patent Application No. 2005-362670 filed in JAPAN on Dec. 16, 2005, the entire contents of which are hereby incorporated herein by reference.

### FIELD OF THE INVENTION

The present invention relates to an image processing apparatus and an interrupt control method, and in particular to an image processing apparatus having a function of interrupt of copy job and the like and an interrupt control method by the apparatus.

### BACKGROUND OF THE INVENTION

In image processing apparatus such as digital multi-function peripheral, there may be needs to urgently and preferentially copy (a) document(s) while a number of documents are being printed. In order to satisfy such needs, some image processing apparatuses have an interrupt function for a current copy job and the like. When this interrupt function is enabled by a user by depressing an interrupt key, the copy job which is being conducted is temporarily stopped and the stopped copy job is resumed after reading and printing processes of intended documents which are set is completed.

In the digital multi-function peripheral, a print engine is usually independent of a scanner engine, so that the reading process of documents can be conducted by the scanner engine while the printing process is conducted by the print engine. A prior art interrupt control method in the digital multi-function peripheral will now be described with reference to FIGS. 10 to 18.

FIG. 10 is a schematic view showing an operation panel provided on a digital multi-function peripheral. In the drawing, a reference numeral 100 denotes the operation panel. The operation panel 100 mainly comprises a display portion for displaying an operation entry screen having a touch panel and an input portion having a ten-key and various operation keys. The display portion comprises a function setting screen 101 for setting various functions and a job state confirming screen 102 for displaying reserved jobs with icons in order.

When a user depresses a “SPECIAL FUNCTIONS” key on the function setting screen 101 in FIG. 10, a screen for setting the special function shown in FIG. 11 is displayed.

A special function setting screen shown in FIG. 11 is a screen for setting special functions which are provided by the digital multi-function peripheral. When a user depressed a “LARGE QUANTITY DOCUMENT MODE”, as shown in FIG. 12, the display “LARGE QUANTITY DOCUMENT MODE” is switched from normal to reverse video and brought into a selected state. When the user further depresses “OK” key, the selected mode is established. Herein “LARGE QUANTITY DOCUMENT MODE” is set, and a screen shown in FIG. 13 is displayed.

When documents are set on an automatic document feeder (ADF) and, as shown in FIG. 14, “START” key on the operation panel 100 is depressed by the user, a reader (scanner engine) provided on the digital multi-function peripheral starts reading the documents. A screen which is displayed at this time is shown in FIG. 15.

An icon for representing that copy job 102a of read documents is reserved is displayed on the job state confirming screen 102 shown in FIG. 15. When the reading of the documents is completed, an “INTERRUPT” key 103 and a document reading completion confirming dialog 104 are displayed on the function setting screen 101 as shown in FIG. 16.

If the “LARGE QUANTITY DOCUMENT MODE” is set, the “INTERRUPT” key 103 is displayed even when the print engine is not printing. Since it is necessary to read a large quantity of documents at this mode, a reading process is conducted at several phases and the “INTERRUPT” key 103 and the document reading completion confirming dialog 104 are displayed each time when reading of one batch of documents is completed.

When the user depresses the “INTERRUPT” key 103 as shown in FIG. 17, the document reading process is temporarily interrupted. Subsequently, as shown in FIG. 18, the reservation priority order of corresponding copy job 102a is decreased and displayed, and the order of the newly interrupting copy job 102b is displayed in the highest priority level. After reading of all documents of the interrupting copy corresponding to the copy job 102b is completed, printing of the interrupting copy is started. After printing of the interrupting copy is completed, the interrupted reading process of documents is resumed.

The “LARGE QUANTITY DOCUMENT MODE” has been described. The same is applied to the usual interrupt printing process. After a user depresses an “INTERRUPT” key to temporarily interrupt a printing process which is being conducted and an interrupt printing process of desired document is conducted, the interrupted printing process is resumed.

Heretofore, in relation to an image processing apparatus having an interrupt function, Japanese Laid-Open Patent Publication H9-46462 discloses an image processing apparatus in which reservation of interrupt is enabled by combining respective operations such as document reading operation and print output operation. When an interrupt is requested by a second operator's key operation while a copy job using an electronic sorting means is being conducted by a first operator, the copy job for the first operator is interrupted, the documents for second operator are read by a document reading means, and the read image data is stored in the electronic sorting means. After only reservation of copy mode of the second operator is accepted and the document reading operation and reservation of copy mode for the second operator is completed, interrupted copy job for the first operator is resumed. After completion of copy job for first operator, the image data is read out from the electronic sorting means in accordance with the reserved copy mode for the second operator to automatically conduct the copy job for the second operator.

If an interrupt processing of copy job is conducted while copies are output in the image processing apparatus such as above-mentioned prior art digital multi-function peripheral, it is necessary to read documents by depressing an “INTERRUPT” key. A user who is not familiar with operations may cause the apparatus to read documents without depressing the “INTERRUPT” key. As a result, the read documents would be registered as copy reservation. Particularly, a user who is not familiar with the operations often unwittingly fails to depress the “INTERRUPT” key, since he or she is not too conscious about whether the digital multi-function peripheral is outputting copies.

### SUMMARY OF THE INVENTION

It is an object of the present invention to provide an image processing apparatus and an interrupt control method for the apparatus in which the output state of an output portion can be determined when input of image data is completed and in which, when previous image data is being output, selection may be made between interrupting previous image data by the input image data and processing the input image data after completion of the processing of previous image data.

Another object of the present invention is to provide an image processing apparatus for processing input image data, wherein said apparatus comprises an input portion for inputting image data; an output portion for outputting said input image data; and a control portion for controlling an interrupt operation and wherein said control portion determines an output state at said output portion when input of image data from said input portion is completed, and if said control portion determines that previous image data is being output, it selects whether interrupt processing in which said previous image data is interrupted by said input image data or consecutive processing in which said input image data is processed after completion of processing of said previous image data.

Another object of the present invention is to provide the image processing apparatus, wherein a plurality of image datas which is input from said input portion are consecutively accepted for processing.

Another object of the present invention is to provide the image processing apparatus, wherein said apparatus further comprises a display portion for displaying a selection screen which enables a user to select said interrupt processing or said consecutive processing and wherein said control portion selects said interrupt processing or said consecutive processing according to a selection instruction from said selection screen.

Another object of the present invention is to provide the image processing apparatus, wherein a waiting condition of other image data which is accepted by said input portion and which is in a waiting state is informed.

Another object of the present invention is to provide the image processing apparatus, wherein after said interrupt processing or said consecutive processing is selected by said control portion, said selected processing is informed.

Another object of the present invention is to provide the image processing apparatus, wherein said control portion determines whether the number of frames of other image data which is accepted by said input portion and which is in a waiting state is equal to or less than a predetermined number and selects said interrupt processing or said consecutive processing based upon a determination result.

Another object of the present invention is to provide an interrupt control method which is conducted in an image processing apparatus comprising an input portion for inputting image data; an output portion for outputting said input image data and a control portion for controlling an interrupt operation, wherein said method determines an output state at said output portion when input of image data from said input portion is completed, and, if it is determined that previous image data is being output, selects either interrupt processing in which said previous image data is interrupted by said input image data or consecutive processing in which said input image data is processed after completion of processing of said previous image data.

### BRIEF DESCRIPTION OF THE DRAWINGS

FIG. 1 is a block diagram showing an exemplary schematic configuration of an image processing apparatus of one embodiment of the present invention;

FIG. 2 is a view showing an exemplary screen displayed on a display portion of a digital multi-function peripheral;

FIG. 3 is a view showing an example of entry keys which is provided in an input portion of the digital multi-function peripheral;

FIG. 4 is a view showing another exemplary screen displayed on a display portion of the digital multi-function peripheral;

FIG. 5 is a view showing an interrupt confirming dialog displayed on a display portion of the digital multi-function peripheral;

FIG. 6 is a view showing another exemplary screen displayed on a display portion of the digital multi-function peripheral;

FIG. 7 is a view showing another exemplary screen displayed on a display portion of the digital multi-function peripheral;

FIG. 8 is a view showing an example of accepted copy job list which is displayed on the display portion of the digital multi-function peripheral;

FIG. 9 is a flow chart explaining an example of an interrupt control method to which the present invention is applied;

FIG. 10 is a schematic view showing an operation panel which is provided on the digital multi-function peripheral;

FIG. 11 is a view showing a screen displayed on the display portion of the operation panel;

FIG. 12 is a view showing a screen displayed on the display portion of the operation panel;

FIG. 13 is a view showing a screen displayed on the display portion of the operation panel;

FIG. 14 is a view showing entry keys on the input portion of the operation panel;

FIG. 15 is a view showing a screen displayed on the display portion of the operation panel;

FIG. 16 is a view showing a reading completion confirming dialog displayed on the display portion of the operation panel;

FIG. 17 is a view showing a screen displayed on the display portion of the operation panel;

FIG. 18 is a view showing a screen displayed on the display portion of the operation panel;

### PREFERRED EMBODIMENTS OF THE INVENTION

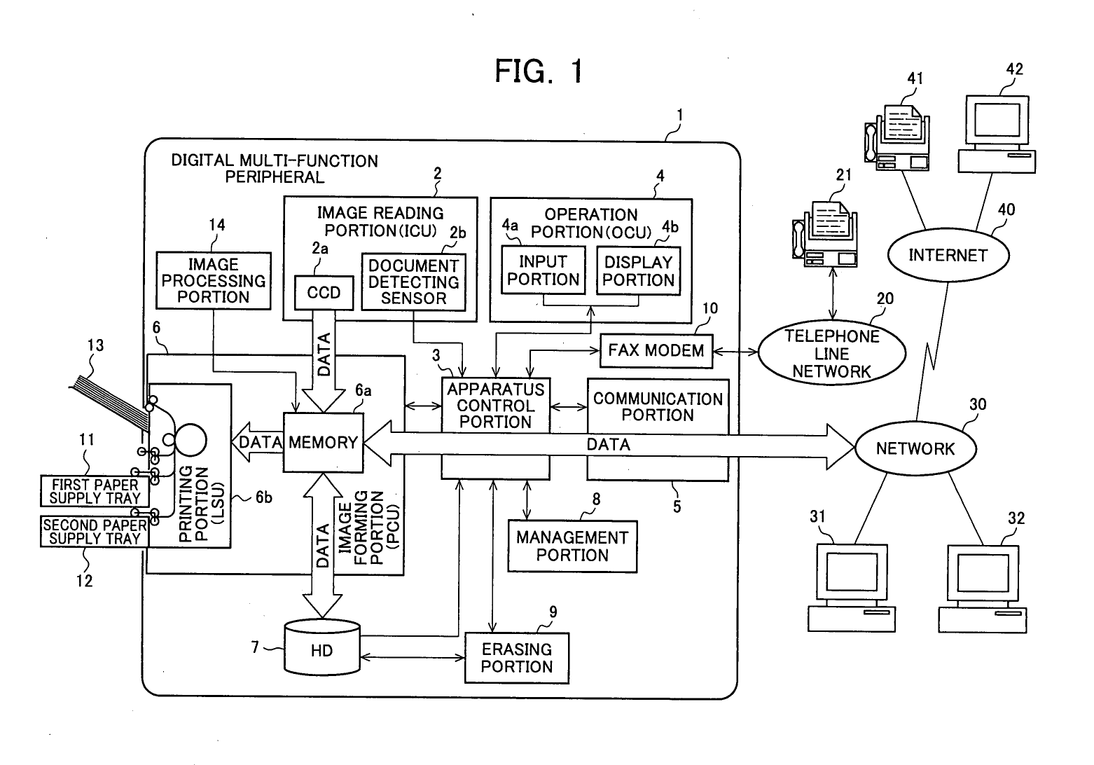

Referring now to FIG. 1, there is shown a block diagram showing an exemplary schematic configuration of an image processing apparatus of one embodiment of the present invention. In the drawing, a reference numeral 1 denotes an image processing apparatus; 20 a telephone line network; 30 a communication network comprising LAN and the like; 21 a facsimile apparatus which is connected with the telephone line network 20; 31 and 32 terminal apparatuses such as personal computers (PCs) which are connected to the communication network 30; 40 the Internet which is a wide area communication network; 41 a facsimile apparatus which is connected to the Internet 40; 42 a terminal apparatus such as PC which is connected to the Internet 40. The image processing apparatus 1 is capable of transmitting and receiving image data or document data to and from the facsimile apparatuses 21, 41 by the facsimile and of transmitting and receiving image data or document data to and from the terminal apparatuses 31, 32, 42 using e-mail and the like.

Now, the image processing apparatus 1 of the present embodiment will be described with reference to a digital multi-function peripheral 1 having a plurality of functions such as those of scanner, copy machine, facsimile and printer.

In FIG. 1, the digital multi-function peripheral 1 comprises an image reading portion (ICU: Image Control Unit) 2 which reads documents to input image data; a machine control portion 3 for controlling the functions of the digital multi-function peripheral 1; and an operation portion (OCU: Operation Control Unit) 4 which accepts user's entries; a communication portion 5 which communicates with the terminal apparatuses 31, 32 via the communication network 30 such as LAN and communicates with the facsimile apparatus 41 and the terminal apparatus 42 via the Internet 40; an image forming portion (PCU; Process Control Unit) 6 which conducts a printing process of image data; a hard disc drive (HD) 7 for storing image data and the like; a management portion 8 which is a memory for storing therein control information and setting information of the digital multi-function peripheral 1; an erasing portion. 9 for erasing image data in the HD 7; and a FAX modem 10 for communicating the facsimile apparatus 21 via the telephone line network 20.

The digital multi-function peripheral 1 further comprises a first paper supply tray 11, second paper supply tray 12 and paper discharge tray 13. The first and second paper supply trays 11 and 12 are detachably mounted on the digital multi-function peripheral 1 to supply the image forming portion 6 with copy sheets on which images will be formed. Copy sheets which are supplied from the first or second paper supply tray 11 or 12 are formed with images at the image forming portion 6 and then discharged on the paper discharge tray 13. The digital multi-function peripheral 1 comprises the image processing portion 14 which conducts various image processes for image data which are input to the image forming portion 6.

Each portion of the digital multi-function peripheral 1 shown in FIG. 1 will be described in detail.

The digital multi-function peripheral 1 comprises the machine control portion 3 having a CPU which conducts an operation and a RAM which stores temporal information associated with the operation. A ROM which stores a control program for controlling the digital multi-function peripheral 1 is included in the machine control portion 3. The management portion 8 which is a memory for storing management information (various items of information) for managing the processing conducted by the digital multi-function peripheral 1 is connected to the machine control portion 3.

The image reading portion 2 which reads images recorded on documents for generating image data is connected to the machine control portion 3. The image reading portion 2 is provided with a CCD (Charge Coupled Device) 2a which scan the image of the documents as image data and a document detecting sensor 2b which detects the presence of the documents set on the document platen or an automatic document feeder (ADF).

The image forming portion 6 which serves as an image forming portion to form image data on a copy sheet is connected to the machine control portion 3. The image forming portion 6 is provided with a memory 6a which temporarily stores image data therein, a printing portion (LSU: Laser Scanning Unit) 6b which forms images from image data stored in the memory 6a to record them on the copy sheet, first and second paper supply trays 11 and 12 which supply the copy sheets for the image formation at the printing portion 6b and a paper discharge tray 13 on which copy sheets are discharged.

The FAX modem 10 for facsimile communication is connected to the machine control portion 3. The FAX modem 10 is also connected to the telephone line network 20. The digital multi-function peripheral 1 is capable of transmitting image data which is generated by the image reading portion 2 to other facsimile apparatus 21 by the facsimile communication via the telephone line network 20 which is connected to the FAX modem 10. The digital multi-function peripheral 1 is also capable of receiving, at the FAX Modem 10, image data which is transmitted from other facsimile apparatus 21 via the telephone line network 20 to form images from the received image data at the image forming portion 6.

The communication portion 5 which enables the digital multi-function peripheral 1 to transmit and receive information to and from external apparatus is connected to the machine control portion 3. The communication portion 5 can be connected to the communication network 30 such as inhouse LAN. The terminal apparatuses 31, 32 such as one or more personal computers (PCs) can be connected to the communication network 30. In a usual situation in which only the digital multi-function peripheral 1 is operated, the communication portion 5 is connected to the communication network 30 to exchange information to and from the terminal apparatuses 31, 32 via the communication network 30.

The digital multi-function peripheral 1 is capable of transmitting image data which is generated by the image reading portion 2 from the communication portion 5 to the terminal apparatuses 31, 32. The digital multi-function peripheral 1 is capable of receiving the image data which is transmitted from the terminal apparatuses 31, 32 for forming images at the image forming portion 6 based upon the received image data.

The communication network 30 is connected to the Internet 40 which is a wide area communication network. The communication portion 5 is capable of receiving image data via the communication network 30 and the Internet 40 from the facsimile apparatus 41 and external terminal apparatus 42 which are connected to the Internet 40 by sending an e-mail with the image data.

The operation portion 4 which accepts user's operation is connected to the machine control portion 3. The operation portion 4 comprises an input portion 4a such as touch panel or ten-key through which information such as operation instruction is input by user's operation and a display portion 4b such as liquid crystal panel which displays information which is necessary for the operation. An authorization code for authorizing user or operator of the digital multi-function peripheral is input into the operation portion 4. The authorization code may be input from an external device via the FAX modem 10 or the communication portion 5.

The hard disc drive (HD) 7 is connected to the machine control portion 3. The HD 7 stores the image data to be processed, for example, which is generated by the image reading portion 2. The erasing portion 9 is connected to the machine control portion 3 so that the erasing portion 9 erases the data recorded and stored in HD 7 under control of the machine control portion 3.

Operation examples of the digital multi-function peripheral 1 will now be briefly described with reference to image processing modes.

(Copy Mode)

When the digital multi-function peripheral 1 of the present embodiment is used as a copy machine, the image data of documents which is read by the image reading portion 2 is output as a hard copy from the image forming portion 6.

The image reading portion 2 comprises CCD 2a, so that the image of the documents which is placed in a reading position can be electronically read. The read image data of the documents is established on the memory 6a as output data and temporarily stored in HD 7. If there is a plurality of documents, these operations of reading and storing is repeated. Thereafter, the image data stored in HD 7 is consecutively read in a proper timing and is fed to the memory 6a in accordance with processing mode which is instructed by the operation portion 4. Then, image data is transferred to the printing portion 6b from the memory 6a in synchronization with the writing timing to the printing portion 6b.

Also in case in which read image data is printed on a plurality of copy sheets, the image data is stored as output data in HD 7 on a page-by-page basis and the image data stored in HD 7 is fed to the memory 6a in conformity with the output mode. The image data stored in the memory 6a is repeatedly transferred to the printing portion 6b a number of times equal to the number of copies in synchronization with the writing timing to the printing portion 6b.

(Printer Mode)

When the digital multi-function peripheral 1 of the present embodiment is used as a printer, the image data which is received via the communication portion 5 is output from the image forming portion 6 via the memory 6a and the like.

The communication portion 5 is wired or wirelessly connected to the communication network 30, so that the communication portion 5 receives image data from terminal apparatuses 31, 32 which are external devices connected to the communication network 30. The thus received image data is fed to the memory 6a as image data to be output on a page-by-page basis and is temporarily stored in HD 7. Thereafter, the image data is fed to the memory 6a again from HD 7 and transferred to the printing portion 6b as is similar to the above-mentioned case in which the digital multi-function peripheral 1 is used as a copy machine.

(Scanner Mode)

When the digital multi-function peripheral 1 of the present embodiment is used as a network scanner, the image data of the documents which is read by the image reading portion 2 can be transmitted from the communication portion 5 to the terminal apparatuses 31, 32 via the communication network 30. Also at this scanner mode, the documents are electronically read by CCD 2a which is provided in the image reading portion 2. The read image data of the documents is established at the memory 6a as output data and is temporarily stored in HD 7. Thereafter, the image data stored is fed to the memory 6a from HD 7 and is transmitted via the communication portion 5 to a desired destination after the communication with the destination which is instructed via the operation portion 4 is established.

(Facsimile Mode)

The communication portion 5 is connected to the facsimile apparatus 41 via the communication network 30 and the Internet 40. The FAX modem 10 may be connected to the facsimile apparatus 21 via the telephone line network 20. When the digital multi-function peripheral 1 of the present embodiment is used as a facsimile apparatus, similar operation is conducted and it is possible to transmit and receive image data to and from external devices.

Components which constitute the digital multi-function peripheral 1 are controlled by the machine control portion 3. The machine control portion 3 monitors instructions for operation from the input portion 4a such as tablet and key bank on the operation portion 4 and appropriately displays information which should be informed to users, such as information on the state of the digital multi-function peripheral by the display portion 4b. Information on each component which is controlled by the machine control portion 3 is managed in the management portion 8. The machine control portion 3 controls the operation of the whole of the digital multi-function peripheral 1 based on such information.

The digital multi-function peripheral 1 of the present invention is configured to determine the output state of the output portion such as the image forming portion 6 when input of the image data from the input portion such as image reading portion 2 is completed, and configured such that, when previous image data is being output, selection may be made between the interrupt of previous image data by current input image data and the processing of the current input image data after the processing of the previous image data while previous image data is being output. Interrupt control at this end is conducted by the machine control portion 3.

The input portion of the present invention corresponds to the image reading portion 2, communication portion 5 and FAX modem 10 (hereafter the image reading portion 2 will be represented as the input portion). It is assumed that the output and control portions of the present invention correspond to the image forming portion 6 and machine control portion 3, respectively. The machine control portion 3 is adapted to control the interrupt operation. A control program for executing this interrupt control is stored in the management portion 8. The machine control portion 3 controls the interrupt operation in accordance with this interruption control program in the management portion 8.

When input of the image data from the image reading portion 2 is completed, the machine control portion 3 determines the output state at the image forming portion 6. If it is determined at this time that previous image data is being output, the machine control portion 3 selects whether the interrupt processing in which the previous image data is interrupted by the input image data or consecutive processing (or reserved processing) in which the input image data is processed after completion of the processing of the previous image data.

The above-mentioned selection between the interrupt processing and consecutive processing may be conducted by a user. In this case, the display portion 4b displays a selection screen which enables the user to select either the interrupt processing or consecutive processing. The selection screen corresponds to an interrupt confirming dialog shown in FIG. 5. The machine control portion 3 selects the interrupt processing or consecutive processing in response to a selection instruction from the selection screen.

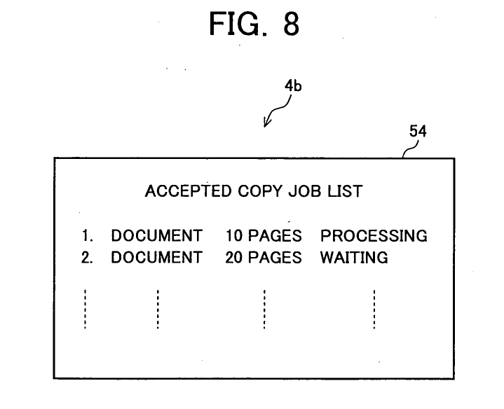

In this case of selection made by user, the user may desire to determine the processing after he or she confirms what and how many copy jobs has been reserved. Accordingly, the waiting condition of other image data which is in the process waiting state may be informed as shown in FIG. 8 described later. This enables the user to select the interrupt or consecutive processing in consideration of the job waiting condition.

Alternatively, selection may be automatically conducted by the digital multi-function peripheral 1. In this case, the machine control portion 3 may determine whether the number of frames of the other image data which is accepted at the image reading portion 2 and which is in the process waiting state is less than or equal to a predetermined number, so that it selects the interrupt processing or consecutive processing based on the determination result. At this time, the image data which is in the processing waiting state may include the remained image data which is being output at the image forming portion 6.

Specifically, the following setting is possible. If the number of frames of the other waiting image data is less than or equal to 100, the consecutive processing is selected. If it is larger than 100, the interrupt processing is selected since a larger period of time is taken to complete this job. The number of frames upon which either processing is selected may be preset to a desired number by a user.

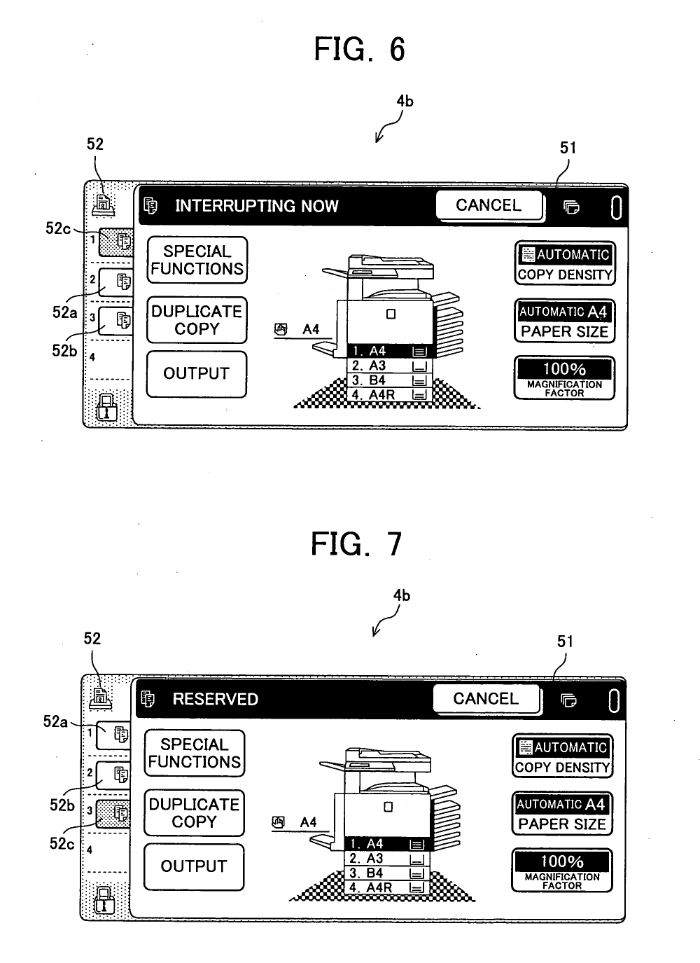

After selection between the interrupt processing and consecutive processing is made by the above-mentioned approach, the display portion 4b may display an icon shown in after-mentioned FIGS. 6 and 7 to inform the user of which processing is selected by the machine control portion 3.

If the interrupt processing is not made or the consecutive processing is selected, the digital multi-function peripheral 1 consecutively accepts a plurality of frames of the image data input from the image reading portion 2 for holding them as, copy jobs and transfers the held copy jobs to the image forming portion 6 in order. The processing order of the copy jobs is an order of accepting inputs. Alternatively, the processing order may be changed by sorting the order after the acceptance of the input.

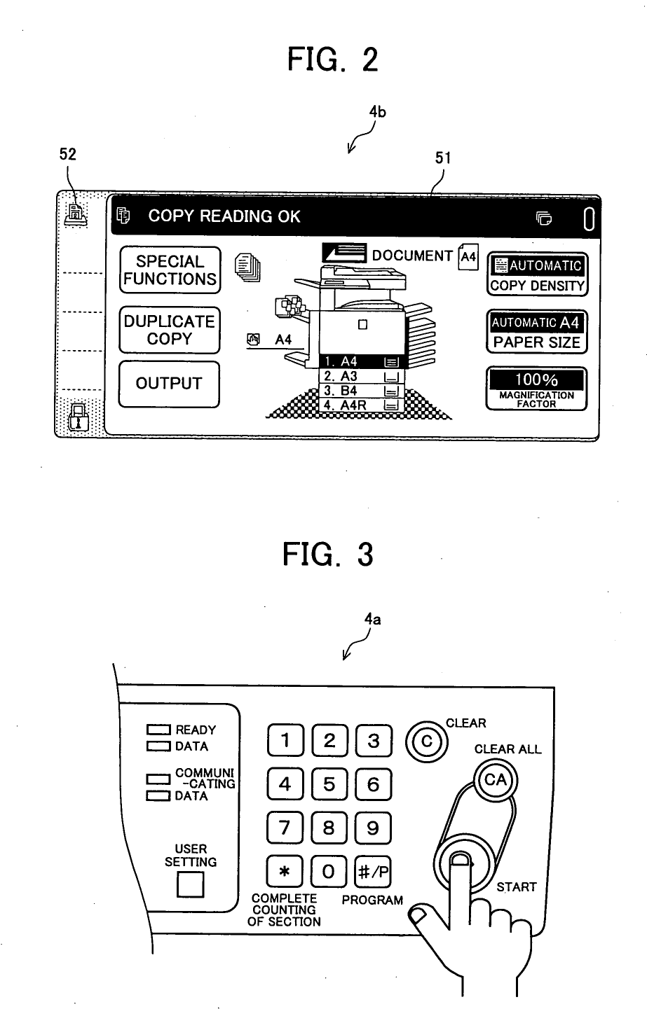

An example of a method of the interrupt control by the digital multi-function peripheral 1 of the present invention will be described with reference to FIGS. 2 to 9.

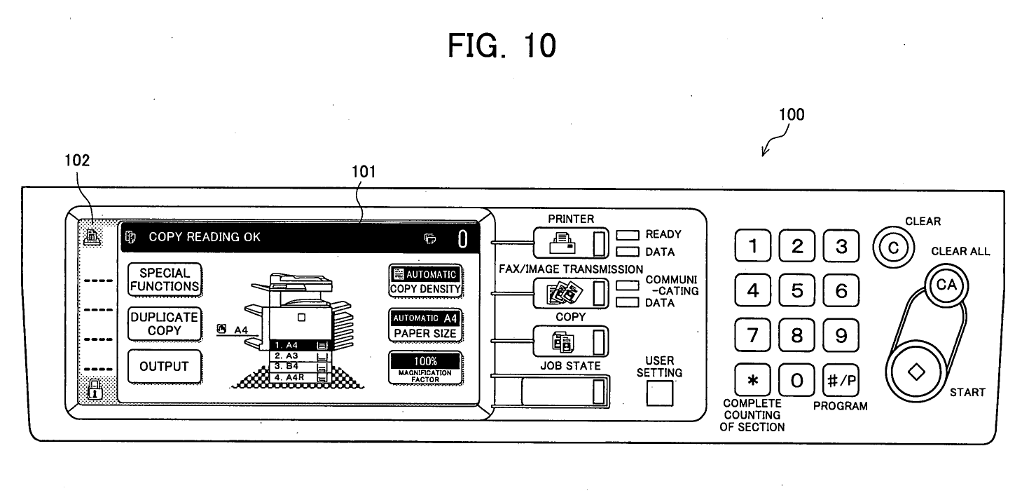

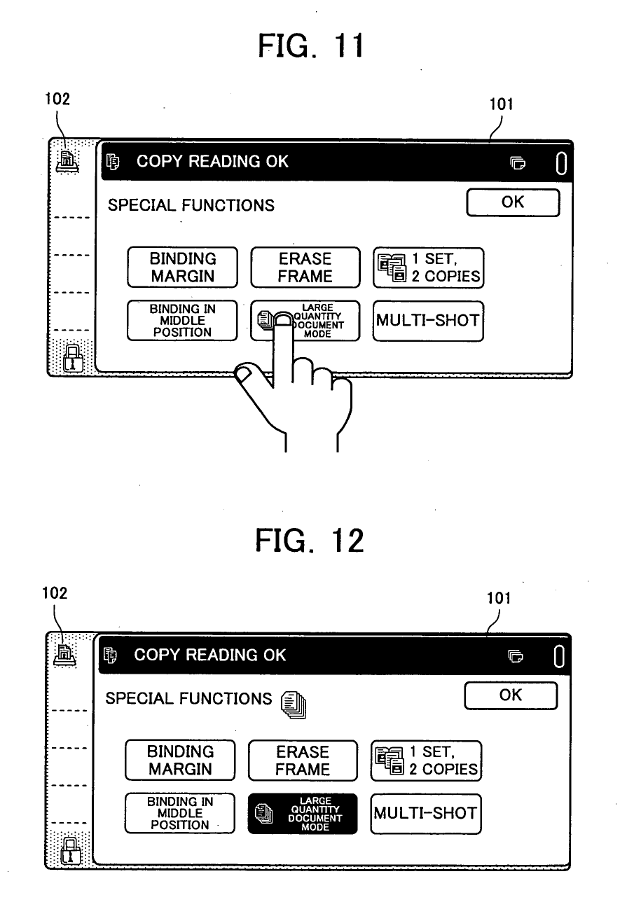

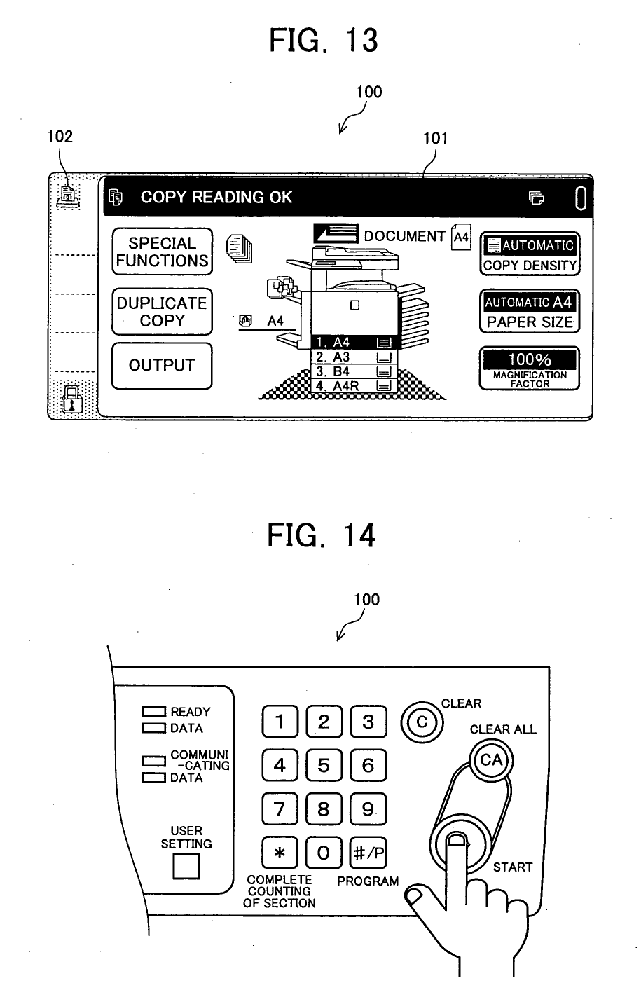

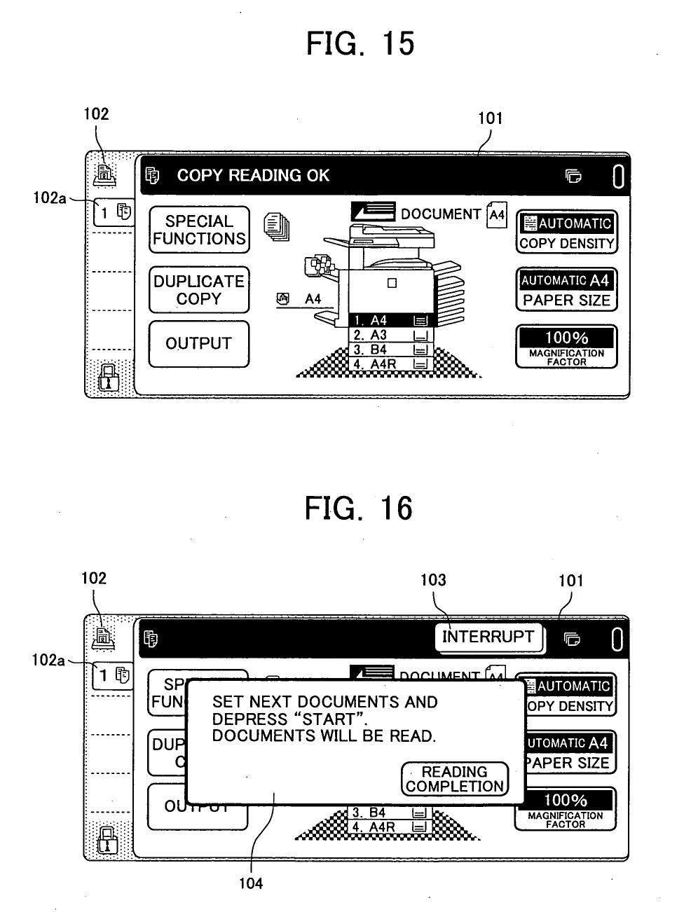

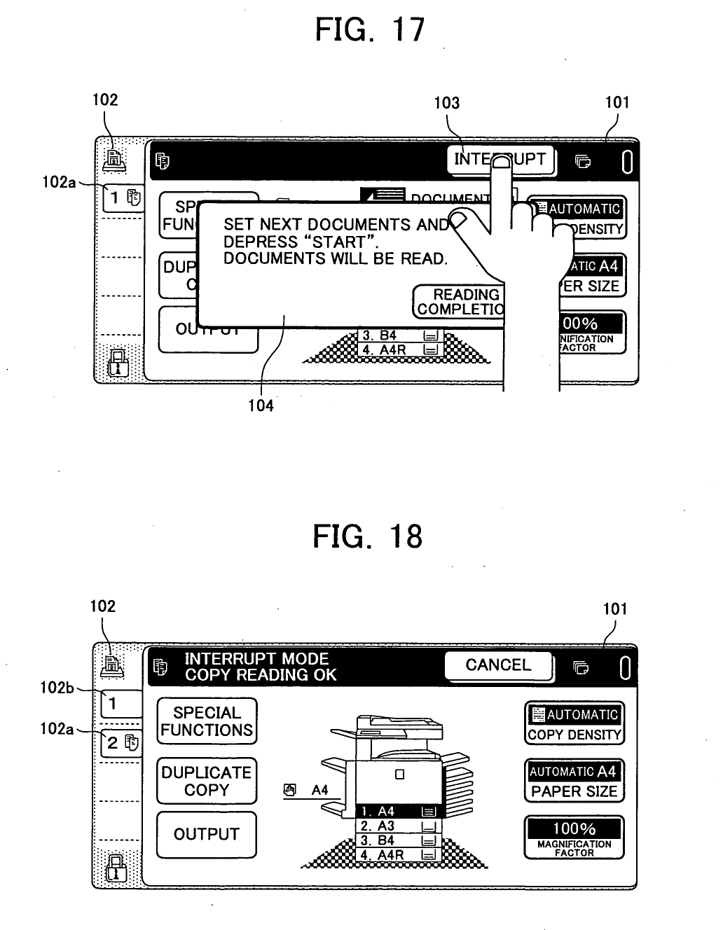

FIG. 2 shows an exemplary screen displayed on the display portion 4b of the digital multi-function peripheral 1. The display portion 4b comprises a touch panel and displays a function setting screen 51 for setting various functions and a job state confirming screen 52 for displaying reserved jobs with icons in order. FIG. 3 shows an example of entry keys and the like included in the input portion 4a of the digital multi-function peripheral 1. The input portion 4a and display portion 4b are provided on the operation panel 100 shown in FIG. 10 described above.

Since the digital multi-function peripheral 1 is capable of conducting a reading process for documents at the image reading portion 2 irrespectively of whether the image forming portion 6 conducts copy output, the digital multi-function peripheral is waiting while displaying a message “COPY READING IS OK !” on the display portion 4b as shown in FIG. 2 even if it outputs copies. If a user wants to copy documents by the waiting digital multi-function peripheral 1, he or she places the documents in interest on an automatic document feeder (ADF) or platen (not shown) and depresses a “START” key of the input portion 4a shown in FIG. 3 to start reading operation.

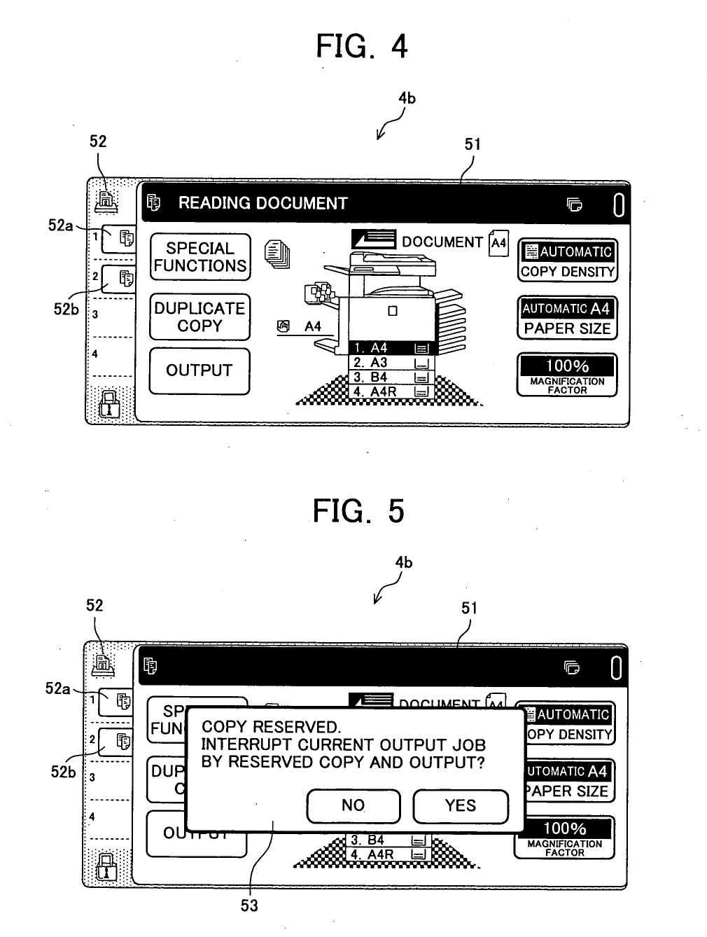

FIG. 4 shows another screen which is displayed on the display portion 4b of the digital multi-function peripheral 1. When the reading process of documents is started, a message “READING DOCUMENT NOW” is displayed on the display portion 4b. If there is any copy job which is already being processed or reserved, the digital multi-function peripheral 1 displays a copy job 52a which is being processed, and a copy job 52b which has been reserved in descendent order of reservation with icons on the job state confirming screen 52.

FIG. 5 shows an example of the interrupt confirming dialog which is displayed on the display portion 4b of the digital multi-function peripheral 1. When reading of documents is completed, the digital multi-function peripheral 1 determines the output state of the image forming portion 6. If it is determined that the image forming portion 6 is outputting previous image data, the digital multi-function peripheral 1 displays, on the display portion 4b, the interrupt confirming dialog 53 for confirming whether to interrupt the copy job of previous image data with the new copy job of read input image data.

FIGS. 6 and 7 show other examples of the screen displayed on the display portion 4b of the digital multi-function peripheral 1. If “YES” is selected on the interrupt confirming dialog 53 shown in FIG. 5 to conduct interrupt copying, the screen of FIG. 5 is changed into a screen of FIG. 6 and the digital multi-function peripheral 1 closes the interrupt confirming dialog 53 and displays a message “INTERRUPTING” and temporarily interrupt a copy job 52a which is in the printing operation for conducting a process of interrupt copy. At this time, a interrupt job 52c (colored icon in the drawing) corresponding to the interrupt copy is displayed in the uppermost level of the job state confirming screen 52, so that the user can be informed of that the interrupt processing is being conducted.

If “NO” is selected in the interrupt confirming dialog 53 shown in FIG. 5 and copy reservation is made without executing interrupt copy, the screen is changed into a screen shown in FIG. 7 and the digital multi-function peripheral 1 closes the interrupt confirming dialog 53 and displays a message “RESERVED” to reserve a new copy job without interrupting the copy job 52a which is in the printing operation. At this time, the newly reserved copy job 52c (colored icon in the drawing) is displayed in the lowermost position of the job state confirming screen 52, so that the user can be informed of that the copy process will be carried out in reserved order.

Also if the digital multi-function peripheral 1 is not operated for a given period of time while the interrupt confirming dialog 53 shown in FIG. 5 is displayed, a new copy job is reserved without interrupting the copy job 52a which is printing as is similar to the above case in which a message “NO” is selected.

FIG. 8 shows an example of an accepted copy job list displayed on the display portion 4b. In the drawing, a reference numeral 54 denotes an accepted copy job list. The accepted copy job list 54 is displayed on the display portion 4b in accordance with the user's operation when a user selects whether or not an interrupt is made on the above-mentioned interrupt confirming dialog 53. The contents of the accepted copy jobs are displayed on the accepted copy job list 54 in order of copy reservation. The user may select whether or not interrupt copy is made after confirming the contents of the reserved copy job.

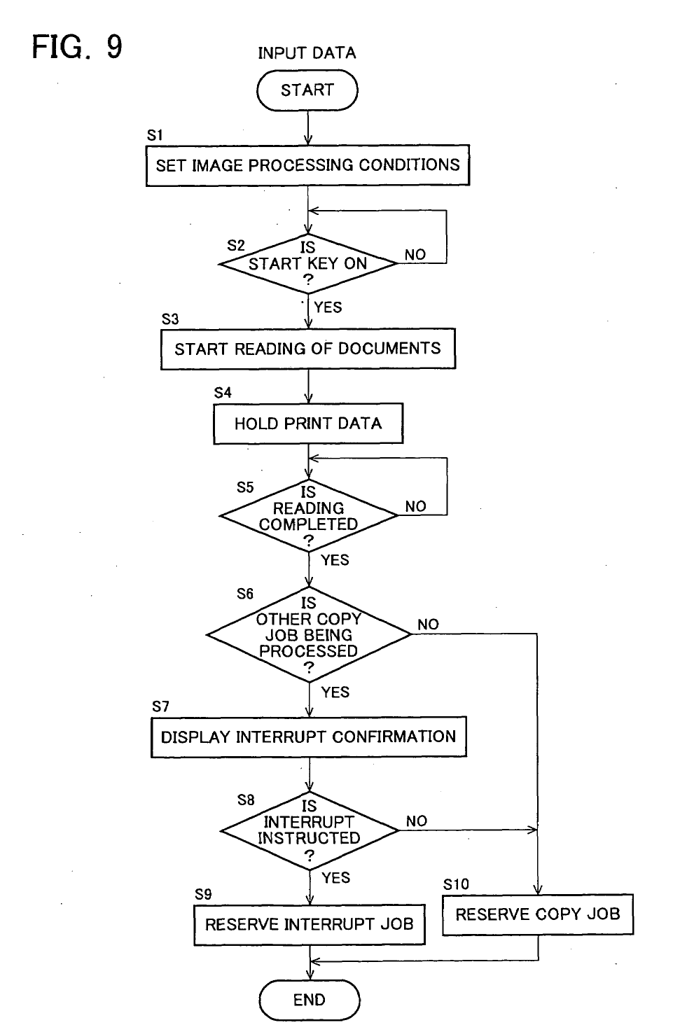

FIG. 9 is a flow chart explaining an example of an interrupt control method to which the present invention is applied. If an image processing condition is set by a user (step S1), the digital multi-function peripheral 1 determines whether a start key is depressed (step S2). If the start key is depressed (YES), the reading process of documents is started (step S3). If the start key is not depressed (NO) at step S2, the process will return to step S2 where the digital multi-function peripheral is shift to a state of waiting for key actuation.

Subsequently, the digital multi-function peripheral 1 holds image data (print data) which are input by reading documents (step S4) and determines whether the reading process is completed (step S5). If it is determined that the reading process is completed (YES), the digital multi-function peripheral 1 determines whether other copy jobs are being conducted (step S6). If it is determined at step S5 that the reading process is not completed (NO), processing at step S5 is repeated.

If the digital multi-function peripheral 1 is processing other copy jobs at step S6 (YES), it displays the interrupt confirming dialog 53 shown in FIG. 5 (step S7). If the digital multi-function peripheral 1 is not processing other copy jobs at step S6 (NO), it reserves the copy job (step S10).

Subsequently, the digital multi-function peripheral 1 determines whether an interrupt is instructed by the interrupt confirming dialog 53 shown in FIG. 5 (step S8) If it is determined that an interrupt is instructed (YES), an interrupting job is reserved (step S9), so that the interrupt processing is executed in accordance with the interrupting job. If it is determined at step S8 that the interrupt is not instructed (NO), processing will proceed to step S10 to reserve a copy job.

The present invention provides advantages as follows: In accordance with the present invention, the output state of the output portion can be determined when input of image data is completed. And selection may be made between interrupting previous image data by the input image data and processing the input image data after completion of the processing of previous image data. Therefore, a user does not have to know whether copies are being output when image data is input and does not have to depress an interrupt key, working for the interrupt processing can be easily conducted.

1. An image processing apparatus for processing input image data, wherein said apparatus comprises an input portion for inputting image data; an output portion for outputting said input image data; and a control portion for controlling an interrupt operation and wherein said control portion determines an output state at said output portion when input of image data from said input portion is completed, and if said control portion determines that previous image data is being output, it selects either interrupt processing in which said previous image data is interrupted by said input image data or consecutive processing in which said input image data is processed after completion of processing of said previous image data.

2. An image processing apparatus as defined in claim 1, wherein a plurality of image datas which is input from said input portion are consecutively accepted for processing.

3. An image processing apparatus as defined in claim 1, wherein said apparatus further comprises a display portion for displaying a selection screen which enables a user to select said interrupt processing or said consecutive processing and wherein said control portion selects said interrupt processing or said consecutive processing according to a selection instruction from said selection screen.

4. An image processing apparatus as defined in claim 3, wherein a waiting condition of other image data which is accepted by said input portion and which is in a waiting state is informed.

5. An image processing apparatus as defined in any one of claims 1 through 3, wherein after either said interrupt processing or said consecutive processing is selected by said control portion, said selected processing is informed.

6. An image processing apparatus as defined in claim 1, wherein said control portion determines whether the number of frames of other image data which is accepted by said input portion and which is in a waiting state is equal to or less than a predetermined number and selects said interrupt processing or said consecutive processing based upon a determination result.

7. An interrupt control method which is conducted in an image processing apparatus comprising an input portion for inputting image data; an output portion for outputting said input image data and a control portion for controlling an interrupt operation, wherein said method determines an output state at said output portion when input of image data from said input portion is completed, and, if it is determined that previous image data is being output, selects either interrupt processing in which said previous image data is interrupted by said input image data or consecutive processing in which said input image data is processed after completion of processing of said previous image data.
